(19) United States
(12) Patent Application Publication
(10) Pub. No.: US 2026/0342656 A1
(43) Pub. Date: Oct. 29, 2026

(54) METHODS AND APPARATUS FOR FEATURE SUPPORT NOTIFICATION

(71) Applicant: Telefonaktiebolaget LM Ericsson (publ), Stockholm (SE)

(72) Inventors: Hong Zhang, Göteborg (SE); Yumei Song, Göteborg (SE); Susana Fermandez Alonso, Madrid (ES); Fuencisla Garcia Azorero, Madrid (ES)

(21) Appl. No.: 19/115,949

(22) PCT Filed: Oct. 11, 2023
(86) PCT No.: PCT/EP2023/078233

§ 371 Date: Mar. 27, 2025

(30) Foreign Application Priority Data
Oct. 20, 2022 (EP) 22383010.0

(51) Int. Cl. H04L 41/0866

(52) U.S. Cl. CPC H04L 41/0866

(57) ABSTRACT

A method and apparatus for feature support notification in a communication network. The method comprises determining, by a network management unit, whether or not feature notifications in relation to one or more features are supported by at least one network unit. If it is determined that feature notifications are supported by the at least one network unit, the method comprises receiving a feature report and sending a feature notification. If it is determined that feature notifications are not supported by the at least one network unit, the method comprises sending a feature notification.

### TECHNICAL FIELD

Embodiments of the present disclosure relate to methods and apparatus in communication networks, and particularly methods and apparatus for feature support notification in communication networks.

### BACKGROUND

Some communication network features, such as 4th Generation (4G) or 5th Generation (5G) wireless networks operating in accordance with the specifications established by the 3rd Generation Partnership Project (3GPP), utilise end to end support from involved network functions of a Protocol Data Unit (PDU) session, including Application Functions (AF), Radio Access Networks (RAN), Session Management Functions (SMF), User Plane Functions (UPF), Policy Control Functions (PCF), Network Exposure Functions (NEF), and so on.

The Application Function (AF) interacts with the 3GPP Core Network and may be used, for example, to exchange information between a Content Provider and a Network Operator. In this context, the content provider is a user of the network, that routes data traffic through the network via the use of network resources. The network operator is the owner and operator of the network, typically a company that charges content providers for use of network resources.

The Policy Control Function (PCF) supports unified policy framework to govern the network behaviour. As an example of this, the PCF may provide PCC (Policy and Charging Control) rules to the Policy and Charging Enforcement Function, PCEF, that enforces policy and charging decisions according to the provisioned PCC rules.

The PCEF may comprise the Session Management Function (SMF) and the User Plane Function (UPF). The Session Management function (SMF) supports different functionality, specifically the SMF may receive PCC rules from PCF and configure the UPF accordingly. The User Plane Function (UPF) supports handling of user plane traffic based on the rules received from SMF, specifically the UPF may support packet inspection and different enforcement actions (e.g. HTTP header enrichment).

The Network Exposure Function (NEF) acts as an entry point into a network for an external Application Function (AF), such as that of a device, where the device may be an IoT device. The NEF thereby securely exposes network capabilities and events provided by 3GPP network functions to external AFs.

Examples of features utilising end to end support include Quality of Service (QOS) monitoring (such as for Ultra Reliable Low Latency Communications(URLLC), Time Sensitive Communications, Redundant transmission for high reliability communication (including Dual Connectivity based end to end Redundant User Plane Paths and support of redundant transmission on N3/N9 interfaces). Several of the features utilising end to end support are key to the correct operation of communication networks. By way of example, QoS monitoring, in addition to helping detect network faults or issues, is commonly included in service agreements. That is, service agreements between network providers and operators often include QoS guarantees (by way of example, guarantees that transmission delays will not exceed a given level) and corresponding penalties for breaching these QoS guarantees. Accordingly, monitoring of QoS parameters is a key task in network operations.

Some of the features utilising end to end support are triggered by an AF interaction. By way of example, 3GPP TS 23.501V17.5.0, a technical specification of the 3rd Generation Partnership Project available at https://portal.3gpp.org/desktopmodules/Specifications/SpecificationDetails.aspx?specificationId=3144 as of 13 Oct. 2022, discusses the provision of QoS monitoring in 5G networks. In particular, section 5.33.3, discusses QOS Monitoring to Assist Ultra Reliable Low Latency Communications (URLLC). Clause 5.33.3.2 specifies the per QoS Flow per User Equipment (UE) QoS monitoring. As discussed in this clause, the SMF, based on QoS monitoring policies received from an AF via the PCF (for example), may send a QoS Monitoring request to the PDU (Protocol Data Unit) Session Anchor (PSA) UPF via N4 signalling and to a Next Generation RAN (Radio Access Network) (NG-RAN) via N2 signalling to request the QoS monitoring between PSA UPF and NG-RAN.

The NG-RAN may initiate the RAN part of uplink/downlink (UL/DL) packet delay measurement based on the QoS Monitoring request from SMF. Further, the NG-RAN may report the RAN part of an UL/DL packet delay result to the PSA UPF in the UL data packet or a dummy UL packet.

The PSA UPF may create and send monitoring packets to the RAN at a measurement frequency, decided by the PSA UPF. In particular:
The PSA UPF may encapsulate in the GPRS Tunnelling Protocol—User Plane (GTP-U) header with QoS Flow Indicator (QFI), a QoS Monitoring Packet (QMP) indicator (which indicates the packet is used for UL/DL packet delay measurement) and the local time T1 when the PSA UPF sends out the DL monitoring packets.
The NG-RAN may record the local time T1 received in the GTP-U header and the local time T2 at the reception of the DL monitoring packets.
When receiving an UL packet from a UE for that QFI or when the NG-RAN sends a dummy UL packet as monitoring response (in case there is no UL service packet for UL packet delay monitoring), the NG-RAN may then encapsulate the QMP indicator, the RAN part of UL/DL packet delay result, the time T1 received in the GTP-U header, the local time T2 at the reception of the DL monitoring packet and the local time T3 when NG-RAN sends out this monitoring response packet to the UPF via N3 interface, in the GTP-U header of the monitoring response packet. When the NG-RAN sends the dummy UL packet as monitoring response to PSA UPF depends on NG-RAN's implementation.
The PSA UPF may then record the local time T4 when receiving the monitoring response packets and calculate the round trip (if not time synchronized) or UL/DL packet delay (if time synchronized) between NG-RAN and anchor PSA UPF based on the time information contained in the GTP-U header of the received monitoring response packet. If the NG-RAN and PSA UPF are not time synchronised, the PSA UPF calculates the UL/DL packet delay between the NG-RAN and the PSA UPF based on the (T2−T1+T4−T3)/2. If the NG-RAN and PSA UPF are time synchronised, the PSA UPF calculates the UL packet delay and DL packet delay between the NG-RAN and the PSA UPF based on (T4−T3) and (T2−T1), respectively. The PSA UPF calculates the UL/DL packet delay between UE and PSA UPF based on the received RAN part of UL/DL packet delay result and the calculated UL/DL packet delay between RAN and PSA UPF. The PSA UPF may then report the result to the SMF based on some specific condition, e.g. when threshold for reporting to SMF is reached.

Typically, there is little or no provision for detection and reporting of issues with QoS monitoring procedures. 3GPP TS 29.244V17.5.0, a technical specification of the 3rd Generation Partnership Project available at https://portal.3gpp. org/desktopmodules/Specifications/SpecificationDetails.aspx?specificationId=3111 as of 13 Oct. 2022, discusses how, when the PSA UPF is performing QoS monitoring and does not receive from the RAN the UL packet delay for a delay exceeding the Packet Delay Thresholds, the UPF may generate a QoS monitoring report indicating packet delay measurement failure to the SMF. FIG. 1 is a bit diagram indicating how the QoS monitoring report indicating packet delay measurement failure may be configured; essentially the bit 4 PLMF (Packet Delay Measurement Failure) bit may be set to “1”, thereby indicating no timestamp has been received in uplink packet for a delay exceeding the Packet Delay Thresholds or the Measurement Period. Further, as discussed in section 6.3.1 of 3GPP TS 29.503V17.7.0, a technical specification of the 3rd Generation Partnership Project available at https://portal.3gpp.org/desktop modules/Specifications/SpecificationDetails. aspx?specificationId=3342 as of 13 Oct. 2022, the UPF may report a packet delay measurement failure to the SMF and the SMF may report the same to the PCF or to the AF. The UPF may make use of the Reporting threshold(s) or the Measurement Period as default threshold for reporting packet delay measurement failure, when no measurement result (no RAN measurement and/or no time stamp in UL packet from RAN) is received for a delay exceeding this threshold. Accordingly, instances of packet delay measurement failure may be communicated between functions in a 3GPP network.

For Dual Connectivity end to end Redundant User Plane paths, TS 23.501 (as cited above), clause 5.33.2, specifies that the SMF determines whether the PDU Session is to be handled redundantly based on an indication that redundant PDU Session is required provided by PCF for the PDU Session, if dynamic PCC applies for the PDU Session. The SMF instructs the UPF and NG-RAN to setup redundant user plane path. The PDU session setup may be successful even though the redundant transmission may not be setup

With the exception of the scenarios discussed above, current systems typically do not provide notifications between different functions that may be used to indicate feature failures, or support (or lack of support) for feature notifications. As a consequence, expected feature reports may be missing without notice, potentially resulting in unexpected errors in the applications expecting the reports. Also, where a UPF relocation results in feature notification support being available that was previously not available (due to lack of support in a UPF used prior to relocation) or vice versa, it is possible that an AF seeking feature notifications may be unaware of the changes in feature notification support availability. Accordingly, the proper operation of the network may be hampered.

### SUMMARY

It is an object of the present disclosure to facilitate the transfer of information relating to feature support notifications in communication networks.

Embodiments of the disclosure aim to provide apparatuses and methods that alleviate some or all of the problems identified.

An embodiment of the disclosure provides a method for feature support notification in a communication network. The method comprises determining, by a network management unit, whether or not feature notifications in relation to one or more features are supported by at least one network unit. If it is determined that feature notifications are supported by the at least one network unit, the method further comprises receiving a feature report and sending a feature notification. If it is determined that feature notifications are not supported by the at least one network unit, the method further comprises sending a feature notification.

A further embodiment of the disclosure provides a method for feature support notification in a communication network. The method comprises sending, by an AF node, a feature notification request to a network management unit. The method further comprises receiving, by the AF node, a feature notification from the network management unit.

A further embodiment of the disclosure provides a network management unit for feature support notification in a communication network, the network management unit comprising processing circuitry and a non-transitory machine-readable medium storing instructions. The network management unit is configured to determine whether or not feature notifications in relation to one or more features are supported by at least one network unit. If it is determined that feature notifications are supported by the at least one network unit, the network management unit is configured to receive a feature report and send a feature notification. If it is determined that feature notifications are not supported by the at least one network unit, the network management unit is configured to send a feature notification.

A further embodiment of the disclosure provides an AF node for feature support notification in a communication network, the AF node comprising processing circuitry and a non-transitory machine-readable medium storing instructions. The AF node is configured to send a feature notification request to a network management unit. The AF node is further configured to receive a feature notification from the network management unit.

Further embodiments provide methods, network management units, AF nodes and systems as discussed herein.

### BRIEF DESCRIPTION OF DRAWINGS

For a better understanding of the present disclosure, and to show how it may be put into effect, reference will now be made, by way of example only, to the accompanying drawings, in which:

FIG. 1 is a bit diagram indicating how the QoS monitoring report indicating packet delay measurement failure may be configured;

FIG. 2 is a flowchart of a method for feature notification in a communication network, in accordance with embodiments;

FIG. 3 is a flowchart of a further method for feature notification in a communication network, in accordance with embodiments;

FIG. 4A and FIG. 4B (collectively referred to as FIG. 4) are schematic diagrams of network management units in accordance with embodiments;

FIG. 5A and FIG. 5B (collectively referred to as FIG. 5) are schematic diagrams of AF nodes in accordance with embodiments; and

FIG. 6A and FIG. 6B (collectively referred to as FIG. 5) are a signalling diagram for a QoS monitoring support notification process according to an example of an embodiment.

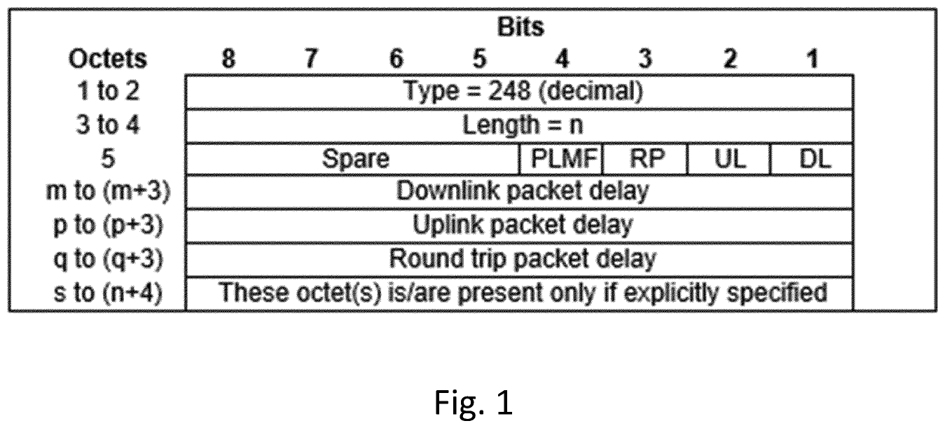

### DETAILED DESCRIPTION

The following sets forth specific details, such as particular embodiments for purposes of explanation and not limitation. It will be appreciated by one skilled in the art that other embodiments may be employed apart from these specific details. In some instances, detailed descriptions of well-known methods, nodes, interfaces, circuits, and devices are omitted so as to not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers that are specially adapted to carry out the processing disclosed herein, based on the execution of such programs.

Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Current systems may not provide reporting capabilities covering a variety of feature notification scenarios, for example QoS monitoring situations (including QoS failures or errors). Two examples of QoS monitoring errors that may not be accounted for in existing systems are: when a SMF detects a UPF does not support QoS monitoring; and when a SMF detects a UPF does not support Direct Notification. With reference to the first of these situations, section 4.3.3.2 step 8 of 3GPP TS 23.502V17.5.0, a technical specification of the 3rd Generation Partnership Project available at https://portal.3gpp.org/desktopmodules/Specifications/SpecificationDetails.aspx?specificationId=3145 as of 13 Oct. 2022 states “If the QOS Monitoring for URLLC is enabled for the QoS Flow, the SMF provides the N4 rules containing the QoS Monitoring policy generated according to the information received in step 1b to the UPF via the N4 Session Modification Request message.” There is no provision for situations in which the selected UPF (selected according to the current selection criteria, such as user location, APN, and so on) for the PDU session does not support QoS monitoring, and/or there is no possibility for the SMF to select a UPF that supports QoS monitoring. With reference to the second of the situations, when a SMF provides N4 rules containing QoS Monitoring policy that contain the Direct Notification indication, it might occur that the relevant UPF does not support the notification to local NEF.

When a network feature function can not be performed due to missing support in one of the network entity involved for a PDU session during the PDU session lifetime, the AF may have no knowledge that function is not working or cannot be fulfilled as long as the same NF is selected for the PDU session (that is, as long as the UE is located in the non-supportive RAN or the selected UPF is not changed). This may lead to unexpected errors in the application. By way of example, in the case of QoS monitoring report, the AF would not identify possible delays in the traffic for URLLC services that would not satisfy the required reliability and thus it cannot take actions as initiating redundant user plane paths for that service.

Aspects of embodiments may provide methods and apparatus for facilitating the transfer of feature support status/reports between network management units (such as SMFs), AFs, PCF, NEFs, UPFs and so on. As such, the various functions and units within the network may have access to more information regarding the availability of support for feature notifications between network functions and units, and the efficient operation of the network may be supported.

By way of example, embodiments may enable the report of QoS monitoring support of, for example, UPFs and/or RAN nodes. The reporting may be enabled as an outcome of the QoS Monitoring Information provisioning. Embodiments therefore provide mechanisms allowing the AF to be aware of the QoS monitoring support in the access network, thereby allowing the AF to react accordingly, avoiding erroneous behaviour in the concerned developed applications. More generally, where a feature may not be homogeneously supported in an operator's deployment, embodiments may enable the report of network feature support status. This may enable detection of situations where one or more of the (re)selectable network entities can't fulfil the feature notification requirements, or can fulfil requirements after previously not being capable of doing so. In some embodiments a SMF may notify a PCF and the PCF may further notify the AF that a network feature is not supported (or it is supported again) for the PDU session so that AF can be notified and making necessary judgement of further actions to be taken

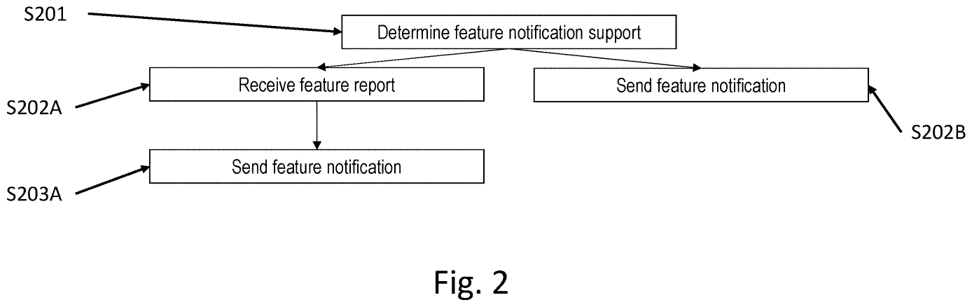

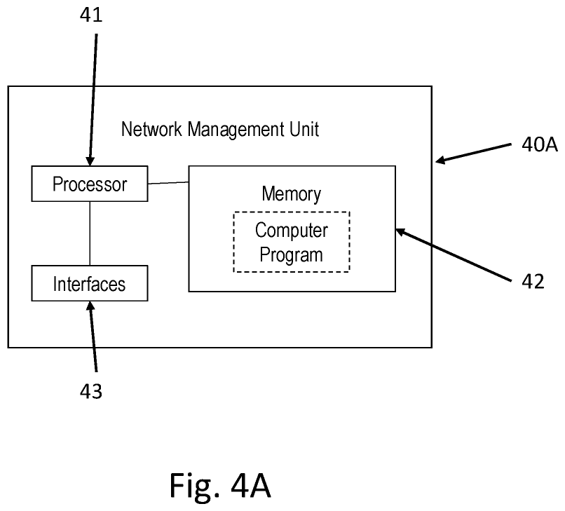

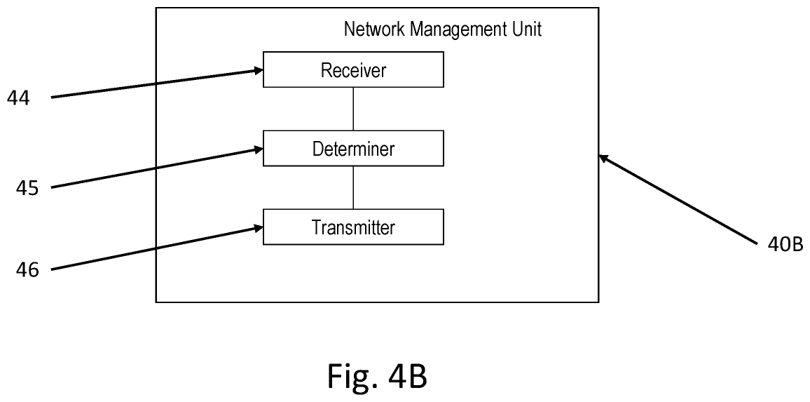

FIG. 2 is a flowchart of a method for feature support notification in a communication network, in accordance with embodiments. The method may be performed by a network management unit (such as a SMF), and may comprise determining, by the network management unit, whether or not feature notifications in relation to one or more features are supported by at least one network unit (see step S201). The determination may be made with respect to one or more network units, which may include one or more UPFs and/or one or more NG-RANs. The network management unit may be, for example, the network management unit 40 of FIG. 4A or FIG. 4B. The determination may be made by the processor 41 of the network management unit 40A shown in FIG. 4A, where the processor 41 may be executing instructions stored in the memory 42. Alternatively, the determination may be made by the determiner 45 of the network management unit 40B shown in FIG. 4B.

In some embodiments, the determination may be made subsequent to the receipt of a feature notification request from an AF, wherein the AF may request information from the network management unit on the QoS monitoring support available from one or more network units for which the SMF provides services. The feature notification request may be received by the interfaces 43 in conjunction with the processor 41 of the network management unit 40A shown in FIG. 4A, where the processor 41 may be executing instructions stored in the memory 42. Alternatively, the feature notification request may be received by the receiver 44 of the network management unit 40B shown in FIG. 4B. In some embodiments, a request for feature reporting may be interpreted as a request for feature support notifications, and therefore no separate request for feature notification support may be required.

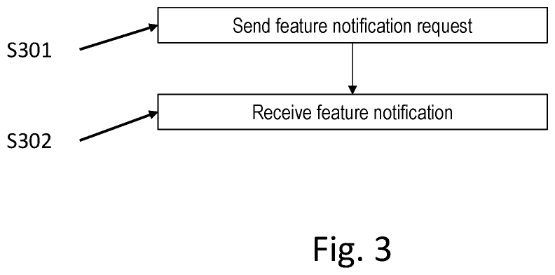

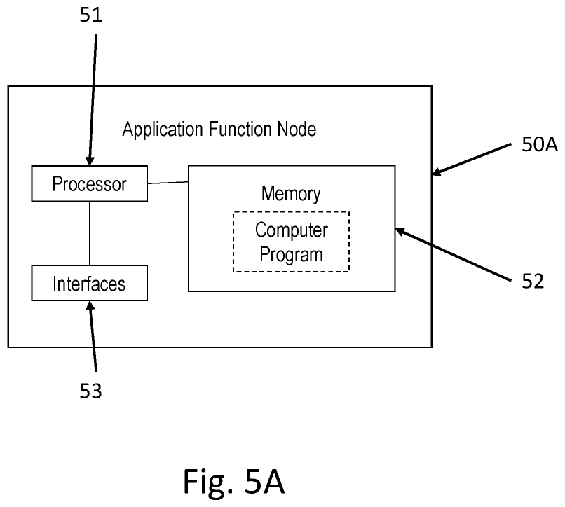

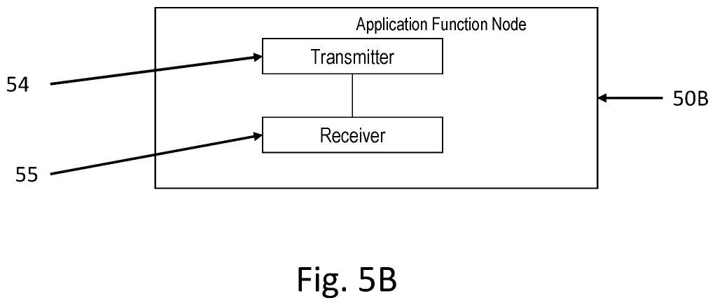

In some embodiments, the feature support notification request may be sent by an AF node 50, as shown in step S301 of FIG. 3. The AF node may be, for example, the AF node 50 of FIG. 5A or FIG. 5B. The transmission of the request may be initiated by the interfaces 53 in conjunction with the processor 51 of the AF node 50A shown in FIG. 5A, where the processor 51 may be executing instructions stored in the memory 52. Alternatively, the transmission of the request may be initiated by the transmitter 54 of the AF node 50B shown in FIG. 5B.

Where a feature notification request is received by the network management unit, the request may pass directly from an AF to the network management unit. Alternatively, the request may be received at the network management unit from the AF via one or more further network components. Where the request passes via further network components, these components may comprise one or more of a PCF and/or a NEF. In some embodiments a NEF may be used, for example, where a feature notification request originates from a 3^{rd} party AF which has restricted access to a PCF (and/or network management unit); where this is the case the NEF may be used to authorise the request and pass the request from the 3^{rd} party AF on to the PCF/network management unit and vice versa.

In order to determine whether or not feature notifications in relation to one or more features are supported by at least one network unit, the network management unit may detect whether the network unit(s) support feature notifications (and/or feature reporting). The network management unit may query the one or more network units (such as UPFs or NG-RAN nodes), for example, following receipt of a feature notification request by the network management unit. Alternatively or additionally, the network management unit may determine whether network units support feature notifications/reporting when connecting to the network units, and may then store this information for subsequent reporting (for example, to an AF) when required. Alternatively or additionally, the network management unit may be sent information from the network unit(s) indicating that feature notification/reporting is or is not supported, and store this information for subsequent reporting.

The information on whether or to what extent (for example for which features) the network unit(s) support feature notifications may be received in the form of a feature report or reports, as shown in step S202A of FIG. 2. The feature report(s) may be received by the interfaces 43 in conjunction with the processor 41 of the network management unit 40A shown in FIG. 4A, where the processor 41 may be executing instructions stored in the memory 42. Alternatively, the feature report(s) may be received by the receiver 44 of the network management unit 40B shown in FIG. 4B. The feature report may be a simple indication that a network unit does or does not support reporting for one or more features, however typically the feature report may specify in more detail what forms of feature notifications are supported by the network unit (for example, the frequency of reports, level of detail provided, and so on). Feature reports may relate to a single network unit, or to a plurality of network units. Alternatively, and particularly where network units do not support feature notifications, the network management unit may not receive a feature report from one or more network units, or may receive a partial report only in respect of some (not all) features. If the network management unit does not receive a feature report from a given network unit within a predetermined time frame, or does not receive a report in respect of some features, the network management unit may determine that the given network unit does not support feature notifications for those features for which no feature report has been received.

Following the determination of whether the one or more network units support feature notifications (which may or may not involve the receipt of one or more feature reports from the network unit(s), as discussed above), the network management unit typically then sends a feature notification (see step S203 of FIG. 2). The feature notification here typically provides information on which features (if any) notifications and reporting may be supported for. As shown in FIG. 2, the feature notification is typically sent when the network units do support feature reporting and notification (S203A), and when the network units do not support feature reporting and notification (S203B), although it is possible that when feature reporting and notification is fully supported, instead or in addition to a feature notification, a full feature status report may be sent. In the FIG. 2 example, no feature report is received by the network management unit prior to the sending of the feature notification indicating that feature reporting/reporting is not supported; in alternative examples a feature report indicating no support may be received by the network management unit prior to the sending of the feature notification. The feature notification(s) may be sent by the interfaces 43 in conjunction with the processor 41 of the network management unit 40A shown in FIG. 4A, where the processor 41 may be executing instructions stored in the memory 42. Alternatively, the feature notification(s) may be sent by the transmitter 46 of the network management unit 40B shown in FIG. 4B.

In some embodiments, particularly when a feature notification request is received from an AF, feature notification(s) may be sent to the AF. The feature notification(s) may be sent directly to the AF, or alternatively may be sent to the AF via one or more further network components (such as a PCF and/or NEF). Typically, although not exclusively, when a feature notification request has been received at the network management unit from an AF via one or more further network components, the resulting feature notification(s) (and reports if applicable) may be sent to the AF via the same further network components. That is, if the feature notification request is received at the network management unit via a PCF and NEF, the feature notification(s) and feature reports if applicable may be received at the AF via the PCF and NEF. The receipt of the feature notification(s) by an AF node in accordance with embodiments is shown in step S302 of FIG. 3. The receipt of the notification may be performed by the interfaces 53 in conjunction with the processor 51 of the AF node 50A shown in FIG. 5A, where the processor 51 may be executing instructions stored in the memory 52. Alternatively, the receipt of the notification may be performed by the receiver 55 of the AF node 50B shown in FIG. 5B.

As discussed above, feature notification(s) may be sent following receipt of a request from an AF. Additionally or alternatively, a further feature notification may be sent following a change of UPF and/or a change of NG-RAN. It may be particularly useful to send feature notification(s) following changes of network unit (such as UPF or NG-RAN) as these changes may result in an alteration in the features that are supported. By way of example, a UPF that supports QoS monitoring and Time sensitive communication monitoring may be changed for a UPF that supports Time sensitive communication monitoring but does not support QoS monitoring, or vice versa. Such alterations of feature notification/reporting capabilities may be useful information for AF. When sent, the further feature notification following a network unit (such as UPF or NG-RAN) change may be received by an AF node; the further feature notification may be received by the AF node directly from the network management unit, or via one or more further network components. In embodiments, the features for which notifications/reports may be sent and received may comprise one or more of: QoS monitoring (in particular but not exclusively for URLLC), Time Sensitive Communications, Redundant transmission for high reliability communication (including Dual Connectivity based end to end Redundant User Plane Paths and support of redundant transmission on N3/N9 interfaces), and so on.

In order to implement embodiments, a new event/Policy Control Request Trigger (PCRT) may be utilised, “FEATURE_SUPPORT”. During the provision of policy for end to end features (such as QoS monitoring, Time Sensitive Communications, and so on as discussed above), the may AF subscribe to a feature specific event such as QOS_MON_SUPPORT and may also or alternatively subscribe to the FEATURE_SUPPORT event. The PCF may subscribe with the SMF (an example of a network management unit) to the report of QoS Monitoring Support outcome by provisioning the QOS_MON_SUPPORT policy control request trigger together with the QoS Monitoring Information for the PCC rule, and may also subscribe to the FEATURE_SUPPORT policy control request trigger. When the SMF receives the QOS Monitoring request for a PCC rule, the QOS_MON_SUPPORT trigger may be provisioned, and equally when the feature support request is received the FEATURE_SUPPORT trigger may be provisioned. It is also possible that the AF, in addition to subscribing to “FEATURE_SUPPORT”, may indicate the features for which it is interested in receiving information; this may be done by including the FeatureSupportReq attribute in the same message. When this information is provided, the PCF will forward the information to the SMF so that it reports the feature support for the features included in the new attribute.

In accordance with embodiments and taking QoS monitoring as an example of a feature for which notifications/reports may be used; when the SMF receives the QoS Monitoring request for a PCC rule for example, the FEATURE_SUPPORT trigger may be provisioned and FeatureSupportReq may indicate QoS Monitoring support status to be reported. If the UPF does not support QoS Monitoring, the SMF may report so to the PCF of the event FEATURE_SUPPORT, including the new FeatureSupport attribute, an enumeration that, in this case, indicates the QoS monitoring feature support status, the QOS_MON_NOT_SUPPORTED. The PCF may then forward the received indication to the AF, in the report of the event FEATURE_SUPPORT.

In accordance with embodiments, when the SMF receives the QoS Monitoring request for a PCC rule indicating Direct Notification, the FEATURE_SUPPORT trigger may then be provisioned and FeatureSupportReq may indicate DirectNotification support status to be reported. Where the UPF does not support Direct Notification, the SMF may report so to the PCF, including the FeatureSupport attribute, an enumeration that, in this example, indicates the QoS monitoring feature support status, the DIRECT_NOTIF_NOT_SUPPORTED. The PCF may then forward the received indication to the AF.

Continuing with the above example, if at UPF relocation the QoS Monitoring or Direct Notification features applicability changes from supported to not supported, the SMF may report the lack of support as described above, including the FEATURE_SUPPORT policy control request trigger. Conversely, if at UPF relocation the QoS Monitoring or Direct Notification features applicability changes from not supported to supported, the SMF may report the available support as described above, but with the FeatureSupport attribute indicating QOS_MON_SUPPORTED or DIRECT_NOTIF_SUPPORTED, and including the FEATURE_SUPPORT policy control request trigger. SMF reporting of FEATURE_SUPPORT and/or QOS_MON_SUPPORT may also be applied to scenarios in which the SMF detects the RAN does not or does support QoS Monitoring/feature notifications.

In some embodiments, the attribute FeatureSupport may include enumeration that indicates status for each network feature not supported or supported. By way of example, QOS_MON_NOT_SUPPORT, DIRECT_NOTIFY_NOT_SUPPORTED may be used to provide information for the QoS monitoring feature. REDUNDANT_UP_PATH_NOT_EST may be used to provide information for Dual-Connectivity-redundant-UP-paths feature. TIME_SENSITIVE_COMMUNICATION may be used to provide information for time sensitive communications, and so on.

Similarly, the new attribute FeatureSupportReq may include enumeration that provides information for end to end (e2e) related features; examples may include QOS_MON, DIRECT_NOTIFY, REDUNDANT_UP_PATH, TIME_SENSITIVE_COMMUNICATION, and so on.

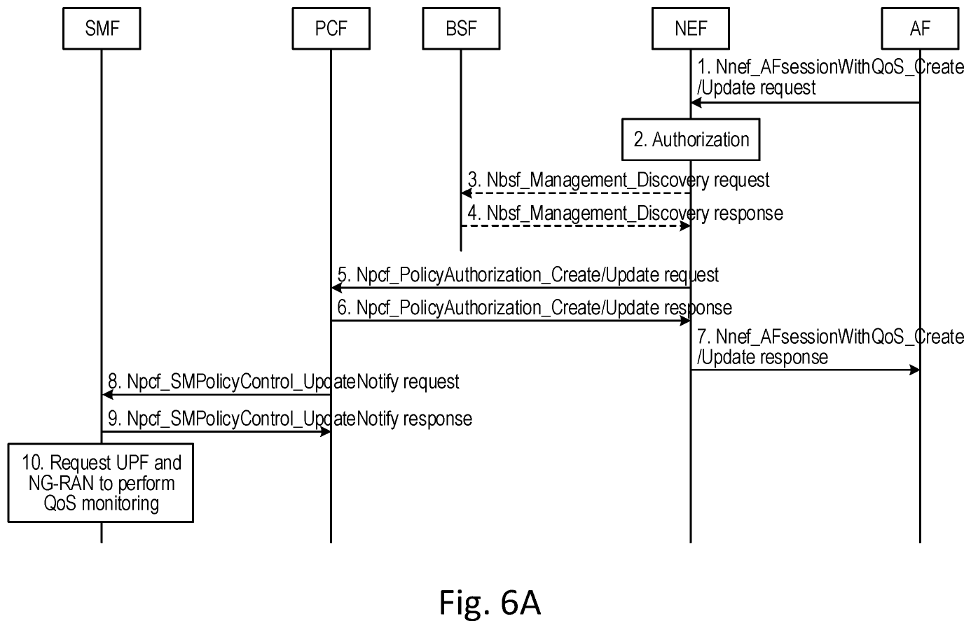

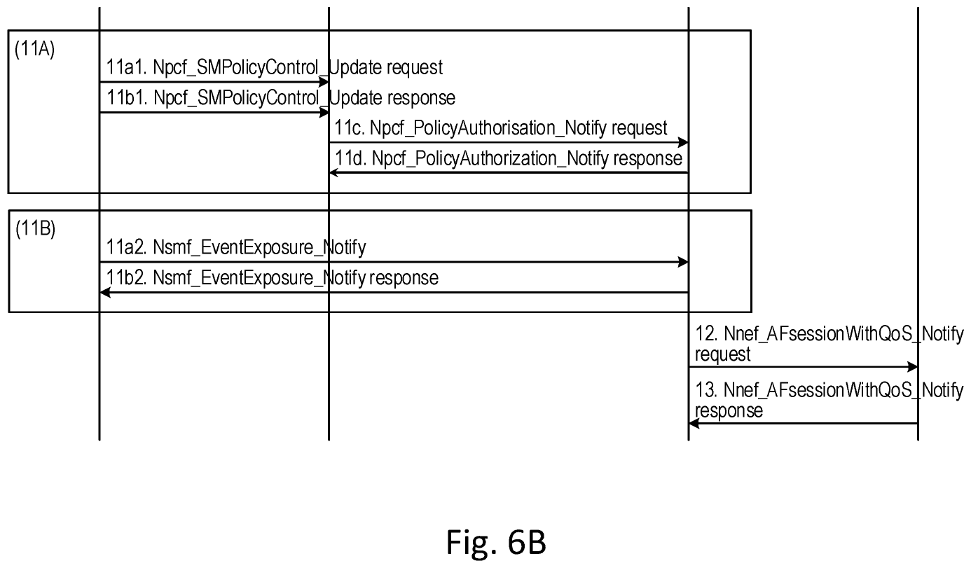

A detailed sequence diagram showing steps which may be performed in an example feature notification/reporting procedure (here, QoS monitoring procedure) in accordance with embodiments is shown in FIG. 6A and FIG. 6B, collectively FIG. 6. One or more of the steps shown in this figure may be omitted. FIG. 6 also includes additional steps which may be used, for example, to establish a session, but which do not necessarily form part of embodiments.

In FIG. 6, the different functions which may be involved in the procedure are indicated across the top of the figure, and the steps that may be performed are numbered down the side of the figure. The functions listed across the top of the figure may be hosted in any suitable physical apparatus, for example, in network management units and/or AF nodes as discussed above.

The FIG. 6 sequence diagram is based on FIG. 5.5.9-1 from 3GPP TS 29.513 V17.7.0, a technical specification of the 3^{rd} Generation Partnership Project available at https://portal.3gpp.org/desktopmodules/Specifications/SpecificationDetails.aspx?specificationId=3354 as of 17 Oct. 2022. TS 29.513 V17.7.0 section 5.5.9 discusses existing QoS monitoring procedures; as deletion related procedures are not relevant to the present disclosure, these have been omitted from FIG. 6.

Further, in the example shown in FIG. 6, a NEF is used to pass communications between the AF and the PCF; as discussed above alternative communication arrangements between an AF and a PCF/SMF may also be used.

As shown in Step 1 of FIG. 6, the AF subscribes to or unsubscribes from the QoS monitoring notification from the PCF via the NEF. To create a subscription to the QoS monitoring information, in the FIG. 6 example the AF invokes the Nnef_AFsessionWithQoS_Create/Update request service operation to the NEF by sending the HTTP POST request to the “AS Session with Required QoS Subscriptions” resource. If the feature “QoSMonitoringSupportReport” is supported, the AF may request the report about the availability of QoS Monitoring and Direct Notification in 5GC. As shown in Step 2 of FIG. 6, the NEF receives and authorises the AF request. More generally, If the feature “NetworkFeatureSupportReport” is supported, the AF may request the report about the availability of a network feature. For example for QoS monitoring feature, the AF may request reporting on QoS Monitoring and Direct Notification in 5GC. The AF may explicitly indicate the feature(s) for which a report is desired in FeatureSupportReq, or may not specify features; where no features are specified in the request, this may be interpreted as a request for information on all available features. To modify an existing subscription to the QoS monitoring information, the AF may invoke the Nnef_AFsessionWithQoS_Update service operation by sending the HTTP PUT or PATCH request to the “Individual AS Session with Required QoS Subscription” resource.

In Steps 3 and 4 of the FIG. 6 example, the NEF may invoke the Nbsf_Management_Discovery service operation, specified in section 8.5.4 of TS 29.513V17.7.0, to obtain the selected PCF ID for the ongoing PDU session identified by the individual UE address in the AF request, where the PCF address is not available on the NEF based on local configuration. This information may be obtained from a Binding Support Function (BSF), as shown in FIG. 6.

As shown in Steps 5 and 6 of the FIG. 6 example, the NEF then forwards the AF request to the PCF. When receiving the Nnef_AFsessionWithQoS_Create request in step 1, the NEF may invoke the Npcf_PolicyAuthorization_Create service operation by sending the HTTP POST request to the “Application Sessions” resource as described in section 5.2.2.2.2.1 of TS 29.513V17.7.0 . When receiving the Nnef_AFsessionWithQoS_Update request in step 1, the NEF may invoke the Npcf_Policy Authorization_Update service operation by sending the HTTP PATCH request to the “Individual Application Session Context” resource as described in section 5.2.2.2.2.2 of TS 29.513V17.7.0 . When receiving the Nnef_AFsessionWithQoS_Delete request in step 1, the NEF may invoke the Npcf_Policy Authorization_Delete service operation by sending the HTTP POST request to the “Individual Application Session Context” resource as described in section 5.2.2.2.2.3 of TS 29.513V17.7.0. Generally, where the feature “NetworkFeatureSupportReport” is supported, the NEF may forward the request about the report about the availability of NetworkFeatureSupportReport in 5GC; in this example ethe NEF may forward the request about the report about the availability of QoS Monitoring and Direct Notification in 5GC. Subsequently, in Step 7, the NEF sends the HTTP response message to the AF. Alternatively or additionally, if the feature “NetworkFeaureSupportReport” is supported and the PCF is aware that a feature is not supported, the PCF may indicate so to the NEF and then (via the NEF) the AF.

In Step 8 of the FIG. 6 example the PCF invokes the Npcf_SMPolicyControl_UpdateNotify service operation to update the SMF with corresponding PCC rule(s) by sending the HTTP POST request to the callback URI “{notificationUri}/update” as described in section 5.2.2.2.1 of TS 29.513 V 17.7.0 If the AF subscribes to QoS monitoring event, the PCF may include the related subscription information within the corresponding PCC rule(s). If the PCF determines that the QoS monitoring event notification should be sent to the NEF directly from the SMF, the PCF received the indication of direct QoS monitoring event notification, the PCF includes the notification URI pointing to the NEF within the “notifUri” attribute, the notification correlation id assigned by the NEF within the “notifCorreld” attribute and the direct QoS monitoring event notification within the “directNotifind” attribute, if available, as specified in 3GPP TS 29.512.

In the present example, if the AF subscribes to the report of QoS monitoring support, the PCF may include the subscription to the QOS_MON_SUPPORT policy control request trigger when updating the SMF. If the AF subscribes to the report of Network Feature Support, the PCF may include the subscription to the FEATURE_SUPPORT policy control request trigger and FeatureSupportReq attribute to indicate interested network feature report if not already done. If the AF unsubscribes from QoS monitoring event/support (or other feature notifications), the PCF may remove the related subscription information from the corresponding PCC rule(s). Additional background information on the communication from the PCF to the SMF may be found in 3GPP TS 29.512V17.7.0, a technical specification of the 3rd Generation Partnership Project available at https://portal.3gpp.org/desktopmodules/Specifications/SpecificationDetails.aspx?specificationId=3352 as of 20 Jul. 2022.

In Step 9 of the FIG. 6 Example, the SMF sends an HTTP 200 OK response message to the PCF. If the PCF subscribed to the report of Network Feature Support events and, and the feature “NetworkFeaureSupportReport” is supported, if the SMF detects that the feature is not supported it will report accordingly to the PCF. For example, if UPF does not support QoS monitoring (there is a PFCP session established with the UPF, and the UPF reports that QoS monitoring feature is not supported), the SMF reports QoS monitoring is not supported to the PCF, if the SMF detects that the UPF does not support Direct Notification, and the PCF requested Direct Notification, (there is a PFCP session established with the UPF, and the UPF reports that Direct Notification feature is not supported) the SMF reports Direct Notification is not supported to the PCF. When any of these situations occur, and the feature “NetworkFeaureSupportReport” is supported between the NEF and the PCF, the PCF invokes the Npcf_PolicyAuthorization_Notify service operation described in step 11c (below) to forward the notification with the network feature support indication to the NEF. Additionally or Alternatively, the SMF may report QoS monitoring is not supported in a subsequent Npcf_SMPolicyControl_Update service operation to the PCF, including the FEATURE_SUPPORT policy control request trigger; this may be the service operations discussed below with reference to steps 11A or 11B.

When the SMF receives the PCC rule, as shown in Step 10 of the FIG. 6 Example, the SMF may send a QoS Monitoring request to one or more of the UPF and NG-RAN (as also discussed in 3GPP TS 29.512V17.7.0 ). When the SMF receives the indication of direct QoS monitoring event notification within the PCC rule, if the UPF supports direct notification, the SMF shall send to the UPF the request to report directly to the NEF the QoS monitoring events.

Subsequently, one of Step 11A and 11B may be implemented. Step 11A may be implemented when, in Step 8, the PCF determines that the notification shall be sent to the NEF via the PCF. Step 11B may be implemented when, in Step 8 the PCF determines that the notification shall be sent to the NEF directly from the SMF.

In Step 11A, specifically in Steps 11a1 and 11b1, upon receipt of the QoS monitoring report from the UPF, or when the SMF detects the NG-RAN does not support QoS Monitoring, the SMF may invoke the Npcf_SMPolicyControl_Update service operation to the PCF by sending an HTTP POST request to the “Individual SM Policy” resource. The QoS Monitoring report may include QOS_MONITORING policy control request trigger, or QOS Monitoring is not supported including the FEATURE_SUPPORT policy control request trigger and FeatureSupport attribute indicating QOS_MONITORING_SUPPORT_NOT_SUPPORTED. The PCF sends an HTTP POST response to the SMF. Steps 11a1 and 11ba are also applicable for RAN or UPF relocation (for example due to mobility events), wherein the use of new RAN or new inserted I-UPF result in feature notification/report capability change from supporting one or more features to not supporting said features or vice versa.

In Step 11A, specifically in Step 11c and 11d, upon receipt of the event notification from the SMF, the PCF may invoke the Npcf_PolicyAuthorization_Notify service operation to forward the notification to the NEF by sending the HTTP POST request to the callback URI “{notifUri}/notify”. The NEF may then send an HTTP POST response to the PCF.

In Step 11B, specifically in Step 11a2 and 11b2, upon receipt of the QoS monitoring report from the UPF, or when the SMF detects NG-RAN does not support QoS Monitoring, the SMF may invoke Nsmf_EventExposure_Notify service operation to forward the notification to the NEF by sending an HTTP POST request to the callback URI “{notifUri}” received in Step 8. The NEF may then send an HTTP POST response to the SMF. Step 11a2 and 11b2 are also applicable for RAN or UPF relocation (for example due to mobility events) wherein the use of new RAN or new inserted I-UPF result in feature notification/report capability change from supporting one or more features to not supporting said features or vice versa.

Subsequently, in Step 12 and Step 13, upon receipt of the QoS monitoring information (as discussed in Step 11), the NEF may invoke the Nnef_AFsessionWithQoS_Notify service operation to forward the QoS monitoring information (QOS monitoring report or, if the feature “NetworkFeaureSupportReport” is supported and it was requested information about QoS monitoring support status, Network Feature Support Report) to the AF.

In some embodiments, at UPF relocation: the new UPF may support feature reports such as the QoS monitoring feature or the Direct Notification feature, wherein it was previously reported that said features (QOS monitoring or Direct Notification) were not supported; or the new UPF may not support feature reports such as the QoS monitoring feature or the Direct Notification feature wherein said features were supported by the previous UPF. Similarly, in some embodiments, at NG-RAN change: the new NG-RAN may support features, wherein it was previously reported that the features were not supported; or the new NG-RAN may not support the features, wherein it was previously reported that the features were supported. In either of these scenarios, if the PCF supports the “NetworkFeatureSupportReport” feature, and the PCF subscribed to the FEATURE_SUPPORT policy control request trigger and interested in QoS Monitoring support report in FeatureSupportReq, the SMF shall send to the PCF the network feature support indication together with the policy control request trigger, as applicable, invoking the Npcf_SMPolicyControl_Update service operation. When this indication occurs, and the feature “NetworkFeatureSupportReport” is supported between the NEF and the PCF, the PCF invokes the Npcf_Policy Authorization_Notify service operation to forward the notification with the network feature support status indication to the NEF.

Where AF sessions are established in accordance with embodiments, the general session establishment procedure as discussed in TS 29.513 (cited above) clause 5.2.2.2 may be modified to include subscription to network feature support status reports. In accordance with existing procedures, when an AF receives an internal or external trigger to set-up a new AF session, the AF invokes the Npcf_Policy Authorization_Create service operation to the PCF by sending the HTTP POST request to the “Application Sessions” resource. The request operation includes the IP address or the MAC address of the UE, the SUPI if available, the GPSI if available, the DNN if available, the S-NSSAI if available, service information, sponsored data connectivity if applicable, AF application identifier, Priority indicator, etc, as defined in clause 4.2.2.2 of 3GPP TS 29.514. The request operation may also include the subscription to notifications on certain user plane events, e.g. subscription to QoS notification control. To invoke MPS for DTS, the AF includes the MPS Action indication as defined in 3GPP TS 29.514. If the “TimeSensitiveNetworking” or “TimeSensitiveCommunication” feature is supported the TSN AF or TSCTSF may subscribe to notification of DS-TT PMIC and/or NW-TT PMIC(s) and/or UMIC availability. The TSN AF or TSCTSF may also provide TSC Assistance Container and QoS related data and/or a UMIC and/or one or more PMIC(s). The AF may provide the Service Information to the PCF by sending a Diameter AAR for a new Rx Diameter session. Additionally, and in accordance with embodiments, if the “NetworkFeatureSupportReport” feature is supported, the AF may subscribe to network feature support status report and the AF interested feature of receiving the report for features which need all involved network entities supports. Although several of the examples discussed herein, such as the example of FIG. 6, are discussed in the context of a 5G network architecture, an analogous procedure may be performed in a 4G network architecture where the RAN supports the required measurements. In an analogous 4G network procedure, the 4G functionality equivalent to the 5G functionality discussed above may equate to replacing: the AF with a Service Capability Server/Application Server (SCS/AS); the PCF with a Policy and Charging Rules Function (PCRF); the SMF with a PDN Gateway Control plane function or Traffic Detection Function Control plane function (PGW-C or TDF-C); the UPF with a PGW User plane function or TDF User plane function (PGW-U or TDF-U); the SMF with a Packet Gateway (PGW) Control plane (PGW-C) or Traffic Detection Function (TDF) Control plane (TDF-C); the UPF with a PGW User plane (PGW-U) or TDF User plane (TDF-U); and the BSF with a Diameter Routing Agent (DRA).

It will be understood that the detailed examples outlined above are merely examples. According to embodiments herein, the steps may be presented in a different order to that described herein. Furthermore, additional steps may be incorporated in the method that are not explicitly recited above. For the avoidance of doubt, the scope of protection is defined by the claims.

1. A method for feature support notification in a communication network, the method comprising:
determining, by a network management unit whether or not feature notifications in relation to one or more features are supported by at least one network unit; and
if it is determined that feature notifications are supported by the at least one network unit, receiving a feature report and sending a feature notification; or
if it is determined that feature notifications are not supported by the at least one network unit, sending a feature notification.

2. The method of claim 1. further comprising:
prior to determining whether or not feature notifications are supported by at least one network unit, receiving a feature notification request from an Application Function (AF); and
sending the feature notification to the AF.

3. The method of claim 2, wherein the feature notification request is received at the network management unit from the AF via one or more further network components, and/or wherein the feature notification is sent to the AF via one or more further network components.

4. The method of claim 3, wherein the one or more further network components comprise a Policy Control Function (PCF) and/or wherein the one or more further network components comprise a Network Exposure Function (NEF).

5. The method of claim 1, wherein the at least one network unit comprises a User Plane Function (UPF);
wherein the method particularly comprises following a UPF relocation, sending a further feature notification to the AF.

6. (canceled)

7. The method of claim 1, wherein the at least one network unit comprises a Next Generation Radio Access Node (NG-RAN);
wherein the method particularly comprises following a NG-RAN change, sending further feature notification to the AF.

8. (canceled)

9. The method of claim 1, wherein the network management unit is a Session Management Function (SMF); and/or
wherein the one or more features comprise:
Quality of Service (QoS) monitoring;
Time Sensitive Communications; and/or
Redundant transmission for high reliability communication.

10. (canceled)

11. A method for feature support notification in a communication network, the method comprising:
sending, by an Application Function (AF) node a feature notification request relating to one or more features to a network management unit; and
receiving, by the AF node, a feature notification from the network management unit.

12. The method of claim 11, wherein the network management unit is a Session Management Function (SMF).

13. The method of clai 11, wherein the feature notification request and/or the feature notification pass between the AF node and the network management unit via one or more further network components:
wherein the one or more further network components in particular comprise a Policy Control Function (PCF), and/or wherein the one or more further network components comprise a Network Exposure Function (NEF).

14. (canceled)

15. The method of claim 11, further comprising receiving a further feature notification following a User Plane Function (UPF) relocation, or receiving a further feature notification following a Next Generation Radio Access Node (NG-RAN) change.

16. (canceled)

17. A network management unit for feature support notification in a communication network, the network management unit comprising processing circuitry and a non-transitory machine-readable medium storing instructions, wherein the network management unit is configured to perform the steps of claim 1.

18.-26. (canceled)

27. An Application Function (AF) node for feature support notification in a communication network, the AF node comprising processing circuitry and a non-transitory machine-readable medium storing instructions, wherein the AF node is configured to perform the steps of claim 11.

28.-32. (canceled)
